(19) United States
(12) Patent Application Publication
(10) Pub. No.: US 2013/0181176 A1
(43) Pub. Date: Jul. 18, 2013

(54) SCISSOR MECHANISM AND METHOD OF USE

(71) Applicants: Joseph Paulk, Jacksonville, FL (US); William Thompson, Perry, FL (US); Troy Thompson, Perry, FL (US)

(72) Inventors: Joseph Paulk, Jacksonville, FL (US); William Thompson, Perry, FL (US); Troy Thompson, Perry, FL (US)

(73) Assignee: Mobex of North Florida, Inc., Jacksonville, FL (US)

(21) Appl. No.: 13/549,275

(22) Filed: Jul. 13, 2012

Related U.S. Application Data
(60) Provisional application No. 61/507,189, filed on Jul. 13, 2011.

(51) Int. Cl. B66F 5/00

(52) U.S. Cl. CPC B66F 5/00
USPC 254/2 R

(57) ABSTRACT

A scissor mechanism comprises a pair of opposed jaws. The opposed jaws are defined at one end of a rigid member. At least one rigid member is pivotably engaged to a base plate. The base plate is capable of being coupled to a mobilization structure that is capable of being rolled on the ground. For example, the mobilization structure may comprise a jack or a bolt that is capable of raising and lowering the base plate. The jaws provide a strong grip on a portion of the shelving either under the influence of a strong biasing mechanism or by using a lever action to force one or more of the jaws closed onto the portion of the shelving. A bump stop may be adjusted to impinge on another portion of the shelving, which may prevent the shelving from tipping or sliding within the pair of jaws.

### RELATED APPLICATION

This application claims the benefit of the filing date of U.S. Provisional Patent Application No. 61/507,189 filed Jul. 13, 2011, the disclosure of which is hereby incorporated herein by reference in its entirety. The field relates to gondola mobilization systems.

### FIELD OF THE INVENTION

The field relates to gondola mobilization systems.

### BACKGROUND

Gondola shelving is a type of shelving used in stores for displaying products in a retail store, for example. Shelving often has a skirt around the bottom of the shelving and mobilization of the shelving requires removal of the skirt to access the legs and supporting frame of the shelving. Gondolas are known with or without a central support column and with one or two sides having shelving attached. Warehouse pallet racking is also known, such as pallet racking used in home centers and warehouses. Unless otherwise expressly indicated, the term gondolas refer to both a single gondola and a gondola run having a plurality of gondolas or both.

Lifting systems are known that use a plurality of caster wheels to mobilize empty gondolas or gondolas that have at least a portion of the racked products removed from the gondolas. U.S. Patent Publication 2007/0194546, published Aug. 23, 2007, and U.S. Patent Publication 2007/0059138, published Mar. 15, 2007 illustrate systems with a screw or hydraulic jack for lifting gondolas, the description and drawings of which are hereby incorporated for background herein. Two devices are disposed on opposite sides of the gondolas at each upright support, which may be accessible behind a kick plate. Each upright support is raised using the lifting apparatus and the gondola, even if quite long, is movable using the lifting system as a hand truck, with each of the hand trucks being moved at the same time.

U.S. patent application Ser. No. 12/364,177, the disclosure of which is incorporated herein, teaches a system for mobilization of stocked gondolas that allows for mobilization without removing shelving and without removing the products from the shelving of the gondolas or pallet racking. The system described a lifting mechanism attachable an H-support or other upright support of pallet racking, such as for use in mobilization of the pallet racking, but only from an exposed front or side of the H-support. Using the system for mobilizing a gondola permits even very deep and very wide gondolas to be mobilized, without unracking and/or disassembly of the gondolas and/or removal of product from the shelves, when a pair of opposing members are positioned such that the members extend along the depth of the gondola from one side to an opposite side. Each pair of opposing members is positioned such that the pair of members is disposed on opposite sides of a gondola support. A slidable middle lift bracket on each of the pair of opposing members is positioned at the middle, upright support of the gondola, and may have additional lift brackets disposed at other upright support members of the gondola. An interlinking tongue and loop system may be used to slide under the supports and to engage one lift bracket to its opposite lift bracket. Thus, the pair of opposing members may provide rigid support to the gondola, when the pair of opposing members are lifted, allowing for mobilization of the gondola. In this system, a modified jack engaged each end of each of the opposing members, such as a screw or hydraulic mechanism coupled with a pair of forks capable of engaging the pair of opposing members, such that the forks raise and lower the pair of opposing members together, at the same time. The forks are fixed in position and are not capable of displacement to make positioning of the jack in narrow inaccessible spaces.

In one example, a hand crank, such as a hand crank and screw similar to that of a boat trailer hitch apparatus, is used to lift a pair of forks inserted into the opposing members. A screw and hand crank is capable of replacing a heavier, more expensive and harder to maintain hydraulic jack, for example, when a plurality of such lift mechanisms are coupled to opposite ends of a plurality of the support apparatuses spaced at intervals along a gondola run. No single lift mechanism is required to exceed its rated lifting potential. The lack of any significant sagging from one side of the gondola reduces the height that the lift must raise the gondola to mobilize it, because the support bar is capable of supporting the supporting structure of the gondola a plurality of support points, such as three or more support points. In some of the examples, three support points are disclosed, but additional support points may be added in other applications requiring support of larger spans, for example.

Single sided gondolas and islands may be raised and lowered similarly to the double sided gondolas provided in the examples. In single sided gondolas, a support bar may be supported on only one side by a lift mechanism or on both sides. If supported on only one side by a lift mechanism, then other end of the support bar may be unsupported, requiring a counterbalance on the lift mechanism, or may be provided with a low-profile caster wheel that provides a fulcrum at an opposite end of the support bar assembly for lifting of the gondola during raising of the end of the support bar assembly attached to the lift mechanism, for example. In this way, a gondola having one side against a wall may be mobilized, for example, using a plurality of lift mechanisms along the side of the gondola facing away from the wall, only, while the low-profile casters inserted into or onto the support bar assemblies allow the support bar assemblies to be inserted and aligned under the gondolas.

Instead of forks, other structures are suggested to mount the lifting apparatus to the support structures used in lifting of the gondolas or to the gondolas, themselves. These other structures may be grabs, bolts or fingers, for example. Grabs are L-shaped extensions from a surface of the lift mechanism that are capable of engaging slots in a coupling mechanism or a gondola. For example, forks may be attached to an attachment member having slots that engage the grabs, allowing the forks to be positioned in the ends of the gondola support bars prior to engaging the lift apparatus to the forks. Then, the lift apparatus may be positioned such that the grabs engage the slots in the attachment member of the forks, and the lift apparatus may be raised until the grabs firmly engage in the slots prior to raising the gondolas. Bolts are fasteners extending from the lift mechanisms that are coupled with nuts or plates having a threaded or other coupling mechanism for attachment to the bolts when inserted through a hole or slot in the gondolas or the attachment member of the forks, for example. Fingers are projections, shaped or straight that matingly engage the gondola or the attachment member of the forks, for example. Thus, when properly engaged to the supports or the gondolas, the lift mechanism provides for a positive displacement upward and downward. However, these other structures did not suggest the use of any structures capable of moving, pivotally, while remaining engaged to the lift mechanism.

None of the known configurations provide a mechanism capable of clamping onto supports using a scissor-like mechanism, i.e. using a pivot point for mechanically positioning a mechanism for clamping the mechanism to a structural component, allowing the mechanism to be used in mobilizing a variety of standard shelving without the use of an elongated center bar or modification to the shelving or the mechanism or mechanisms used for clamping and raising the gondola shelving.

### SUMMARY

A coupling mechanism comprises a scissor mechanism that is capable of engaging a low profile portion of the coupling mechanism to a leg of a gondola or other shelving without the necessity to remove skirting, for example. In one example, the scissor mechanism operates in a horizontal plane. For example, a biasing mechanism, such as a spring, forces a coupling end of a scissor mechanism to couplingly engage a leg of a gondola. Two lever arms extending opposite of the coupling end are coupled to a plate and may be arranged, such that when pulled apart or pushed together, the coupling end opens and/or closes, for example. The biasing mechanism may bias the coupling end closed. In one example, the coupling end includes flared extensions that initially contact a leg, such that the leg spreads the coupling end when the coupling mechanism is pushed under the shelving.

For example, when a leg of a gondola that extends to the floor, supporting the gondola, is to be coupled to the coupling mechanism, the coupling mechanism is maneuvered such that the gondola leg fits between the flared extensions of the coupling end. The gondola leg contacts the flared extensions, displacing the flared extensions outwardly until the gondola leg clears the flared extensions. As the gondola leg clears the flared extensions, the coupling end closes on the gondola leg, coupling the coupling mechanism onto the gondola leg; the biasing mechanism applying a force on the coupling end. In one example, the bias force of the biasing mechanism is sufficient to fixedly clamp the coupling end to the gondola leg, allowing the gondola leg to be lifted by raising the coupling mechanism using a jack.

In an alternative example, the bias force is not adequate to fixedly clamp the coupling end to the gondola leg. Instead, an adjustable bump stop adjustably engages an outwardly facing surface of a portion of the gondola, while the coupling end engages a surface of a portion of the gondola opposite of the outwardly facing surface. For example, the coupling mechanism may be coupled to a jack of a mobilization truck, such that the jack is capable of raising the coupling mechanism. The bump stop or the bias mechanism is capable of clamping the coupling end onto the gondola leg, such that the jack is capable of raising the coupling mechanism, which raises the gondola leg, if the leg is clamped by the coupling mechanism.

In another example, a rotatable coupling mechanism includes a lever capable of rotating a coupling end up to one hundred eighty degrees, such that the coupling end is open in a first position of a lever aim and is rotated into a closed position in a second position of the lever arm. A second lever arm may be rotated to pull the coupling end, when in the closed position, into contact with a gondola leg, biasing the coupling end against the gondola leg, such that the gondola leg raises when the coupling mechanism is raised by a jack.

The rotatable coupling mechanism may be attached to a jack of a mobilization truck in the same manner as the coupling mechanism including a coupling end arranged on one end of a scissor mechanism. In this way, the user is allowed to choose one or the other examples of coupling mechanisms as needed to engage different types of gondola legs using the same mobilization truck.

Both coupling mechanisms may include an adjustable bump stop that engages a surface of the gondola, such as the leg, support or skirt portion of the gondola. For example, when either of the coupling mechanisms are secured to the gondola and is mounted on the jack of a mobilization truck, then raising the jack raises the gondola. By using a plurality of mobilization trucks and coupling mechanisms, an entire gondola run may be raised above the floor, allowing the entire gondola run to be mobilized.

One advantage of the use of a bump stop and a coupling mechanism to clamp a portion of a gondola is that the mobilization truck may be attached to the gondola without removing the gondola skirt, without removing products from the shelves, and without the need to fix any other structure under the shelving. Such an arrangement rapidly couples to the shelving structure for rapid mobilization of the shelving structure.

In one example, an apparatus for raising and mobilizing stocked shelving, comprises a pair of opposed jaws, each of the jaws being defined at the end of one of a pair of rigid members extending from a base plate. For example, at least one of the rigid members comprise a pivot point pivotably coupled to the base plate such that the jaws are capable of being opened and closed by pivoting the at least one of the rigid members about the pivot point. A biasing mechanism may be coupled with the at least one of the rigid members, such that the jaws are biased either open or shut, and an attachment mechanism may be provided for coupling the base plate to a structural member of a mobilization device. The mobilization device may comprise a raising and lowering mechanism for raising and lowering the base plate in relation to the mobilization device, and the mobilization device rolls over the ground for mobilizing stocked shelving. The mobilization device may use roller bearings or wheels for rolling over the ground, preferably castor wheels, in one example. For example, the mobilization device includes a pair of castor wheels disposed on opposite ends of the structural member.

In one example, the attachment mechanism threadingly engages a portion of the structural member. For example, the portion of the structural member comprises a bolt, and the base jaws may be capable of extending all of the way down to the ground without disengaging from the bolt. The biasing mechanism, such as a spring, may be mounted under tension to an end of the at least one of the rigid members opposite of the pivot point from the jaw of the at least one of the rigid members, such that the at least one of the rigid members is biased open by the biasing mechanism. An end of the spring opposite of the at least one of the rigid members may be attached to the plate and need not be attached directly to the other of the rigid members. Alternatively, the spring may be attached between the two rigid members, each of which may be pivotably coupled to the base plate, and the biasing mechanism may be compressed between the pair of rigid members, for example.

In one example, one rigid member is fixedly mounted to a surface of the base plate and cannot pivot in relation to the base plate. For example, the other rigid member can be pivoted into the closed position by closing a lever action to force and retain the jaws closed on a portion of the shelving.

When the biasing mechanism is compressed between a pair of pivotable, rigid members on an end opposite of the pivot point from the jaws, the pair of opposed jaws are biased closed by the biasing mechanism. In this example, each of the ends of the pair of opposed jaws may extend outward from the pivot point and may be tapered such that inserting a portion of the shelving between the tapered ends opens the jaws (i.e. overcoming the biasing force) around the portion of the shelving. The biasing mechanism closes the pair of opposed jaws onto the portion of the shelving when the portion of the shelving is fully inserted between the pair of opposed jaws.

An adjustable bump stop may extend from the base plate such the adjustable bump stop contacts a portion of the shelving when the shelving is inserted between the pair of opposed jaws.

A jack may be included with the apparatus utilizing the scissor mechanism, which is raised and lowered to raise and lower the shelving just about the ground during mobilization of stocked shelving.

When the biasing mechanism is mounted under tension to an end of one of the a pair of rigid members opposite of the pivot point from the jaws, the jaws are biased open by the biasing mechanism. In one example, a pivoting member may be pivotably coupled to the base plate such that in a closed position, the pivoting member engages the end of the one of the pair of rigid members such that the pair of opposed jaws are closed. Using this as a closing mechanism applies a firm clamping mechanism and prevents the jaws from opening until the pivoting member is pivoted to an open position. For example, a wrench may be used for opening and closing such a pivoting member. The pivoting member may couple to a nut on an opposite side of the base plate by a shaft extending through a hole in the base plate, for example. Alternatively, the pivoting member may be activated using a lever arm.

### BRIEF DESCRIPTION OF THE DRAWINGS

FIG. 1 illustrates shelving mobilized using a plurality of mobilization trucks, each truck being coupled with one of the coupling mechanisms.

FIG. 2 illustrates an example of a mobilization truck coupled to one of the coupling mechanisms with a portion of the shelving removed to show the bump stop engaging a portion of the shelving.

FIG. 3 illustrates one example of a coupling mechanism.

FIG. 4 illustrates another example of a coupling mechanism.

FIGS. 5A and 5B illustrate another example of a mobilization truck utilizing a scissor mechanism.

### DETAILED DESCRIPTION

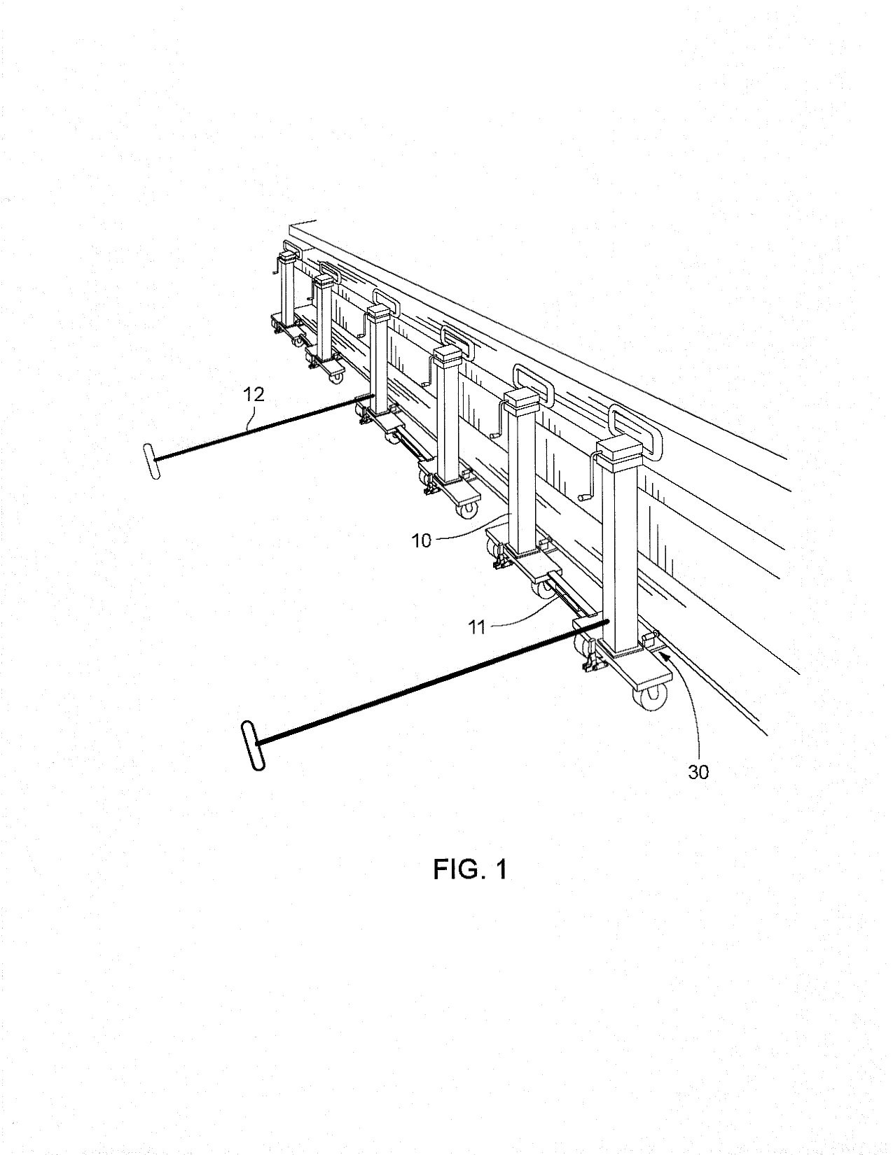

The examples illustrated in FIG. 1 show coupling mechanisms being used according to an exemplary method to mobilize stocked shelving. A plurality of trucks 10 each have coupling mechanisms 30 attached, coupling the trucks 10 jacks to the shelving. Each of the coupling mechanisms 30 are raised by the jacks, such that the shelving is mobilized. Pull bars 12 may be attached to a plurality of the trucks 10, and tie bars 11 engage pair of neighboring trucks 10 together, allowing a few individuals to mobilize an entire gondola run.

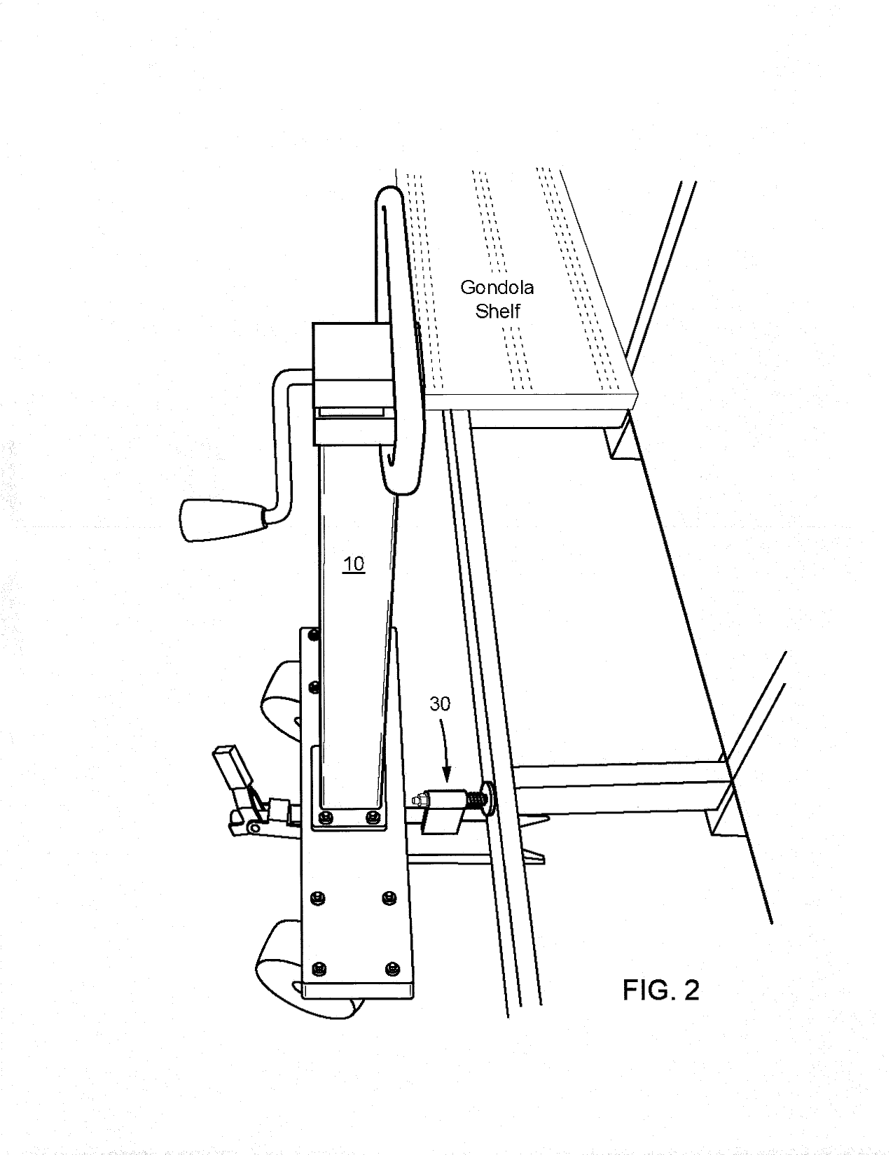

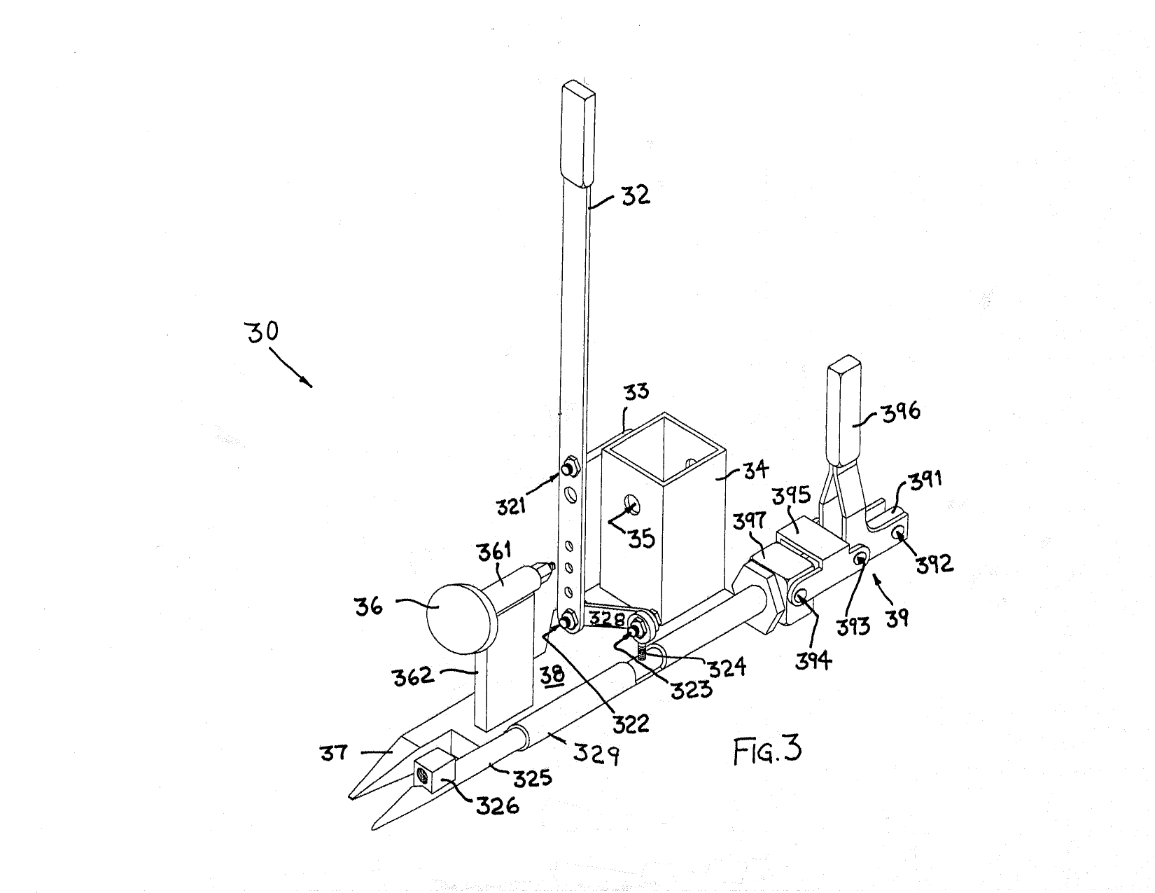

FIG. 2 illustrates an example of one coupling mechanism 30 attached to a truck 10 and clamped to a structure of a gondola shelf. Some of the shelving has been removed to make the position of the coupling mechanism 30 on the structure more readily understandable. As illustrated in detail in the example of the drawing of FIG. 3, a bump stop 36 on one side of the structure contacts a structure of the gondola. As illustrated in FIG. 3, a rotatable fixture 326 is disposed on a bolt 325, such that the rotatable fixture 326 is rotatable. When rotated, the rotatable fixture 326 is capable of being positioned on the opposite side of the structure from the bump stop 36. The bolt 325 is coupled to a lever mechanism 396, which may be capable of applying a force along the longitudinal axis of the bolt 325, such that the fixture 326 and the bump stop 36 clamp the structure between them, when the fixture 326 is properly positioned, rotationally put into a clamping position and clamped using the lever mechanism 396.

In the particular example of FIG. 3, a lever 32 is connected at a first pivot point 321 to an attachment mechanism 34 for attaching the coupling mechanism 30 to a truck 10, and the lever 32 is connected at a second pivot point 322, joining the lever arm 32 via a linkage arm 328 to a third pivot point 323. The third pivot point 323 couples the lever arm 32 to a bolt 325 via a threaded member 324 extending radially from the bolt 325 and through a slot formed in a tubular sheath 329 through which the bolt 325 passes. The threaded member 324 may be threadingly engaged to the bolt 325, allowing the bolt 325 to be introduced into the sheath 329 prior to threadingly engaging the member 324 to a tapped hole in the bolt 325, for example. Other mechanisms than a threaded member 324 may be used to provide a rigid connection between the third pivot point 323 and the bolt 325.

In one example, the bolt 325 extends through a tubular sheath 329 that is attached to a base 38 of the coupling mechanism 30. The base 38 extends rigidly from an attachment mechanism 34, which may be designed to be attached removably to a truck 10, for example. A pin may be inserted through the hole 35 bored through a portion of a tubular attachment mechanism 34, when positioned onto or within a tubular portion of the truck 30 that mates with the tubular attachment mechanism 34, in order to couple the tubular attachment mechanism 34 to the truck 10.

On one end of the bolt, the rotatable fixture 326 extends from the bolt 325 for engaging the reverse side of the structure of gondola shelving, for example. The opposite end of the bolt 325 may be engaged through a block 379 and is coupled to a locking lever 396 at a locking lever pivot point 392. The locking lever 396 may be coupled to a locking linkage 395 at a linkage pivot point 393 disposed on one side of the locking linkage, and the locking linkage 395 may be coupled to the block 397 at a block pivot point 394 at an opposite side of the locking linkage. Thus, rotation of the locking lever 396 is capable of pushing or pulling the bolt 325 through the sheath 329, which displaces the fixture 326 along the longitudinal axial direction of the bolt 325.

Both the position of a contact surface of the bump stop 36 and a contact surface of the fixture 326 may be made adjustable, such that the contact surface making contact with the structure of the gondola shelving is capable of being adjusted to and from a bump stop coupling mechanism 361 attached to the base plate 38 by a support 362, as illustrated in FIG. 3, for example. The fixture 326 in FIG. 3 shows a tapped bore hole extending through the fixture 326 that may be used for adjustably inserting a threaded pin having a contact surface adjustable to and from the fixture 326, for example, allowing adjustment of the distance between the contact surface of fixture 326 and the surface of the bump stop 36, when a lever handle 396 arranged as illustrated in FIG. 3, is actuated to clamp a structure of the shelving between the fixture 326 and the bump stop 36.

The lever arm 32 in FIG. 3 provides for scissoring the arm 32 and the extension 328 about pivot point 322, in a vertical plane, when the lever arm 32 is pivoted about the lever arm's pivot point 321, for example, which is capable of rotating a low profile fixture 328 from an open position, such as at zero degrees, to a closed position, such as at one hundred eighty degrees, for example. The lever arm's pivot point 321 may be coupled by a structural member 33 to the base plate 38 and/or the truck coupling member 34, which is attached to the base plate 38, for example. The low profile of the coupling mechanism 30 allows the coupling mechanism 30 to be inserted under the shelving without the necessity of removing skirting from the shelving, for example.

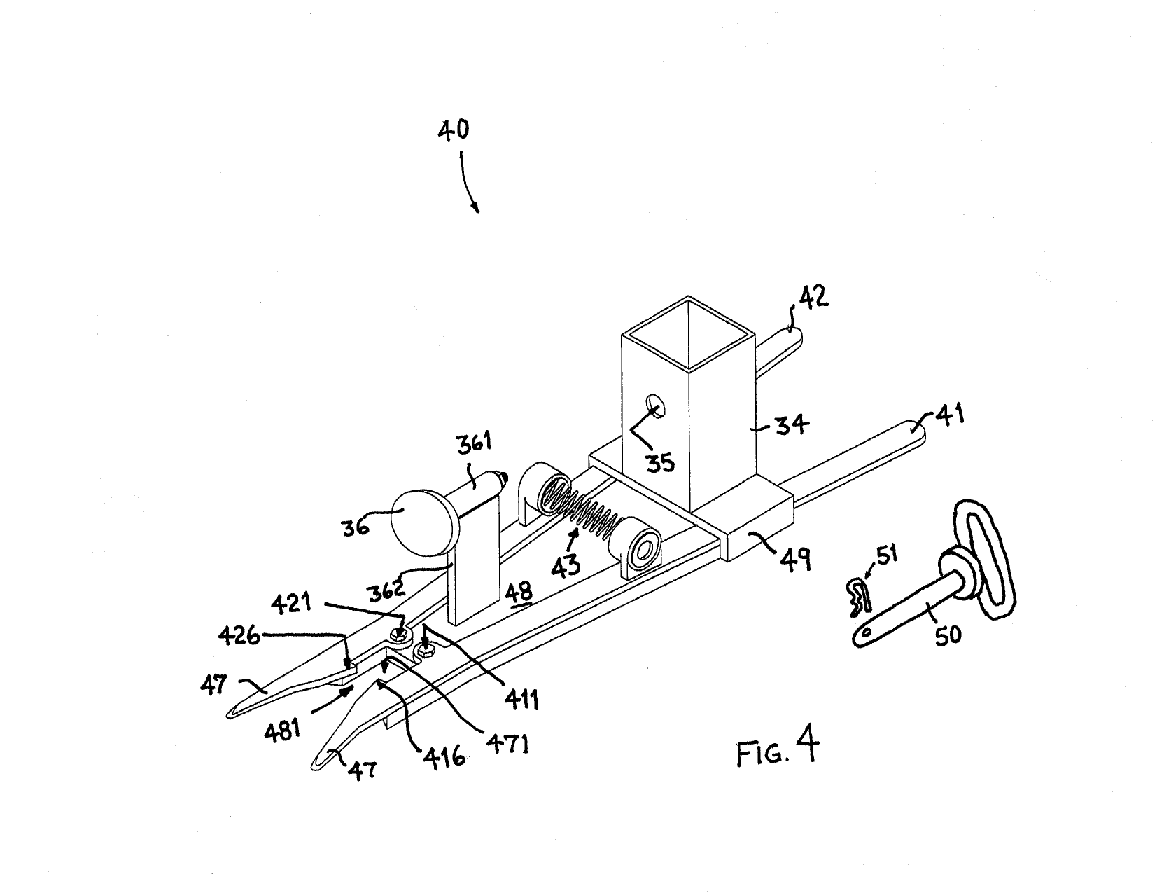

In an alternative example, as illustrated in FIG. 4 for example, a scissor mechanism may be provided in a horizontal plane in another low profile coupling mechanism 40. For example, a biasing mechanism 43 is capable of biasing a coupling end 47 of a scissor mechanism to couplingly engage a structure of a gondola, such as a leg or foot. The biasing mechanism 43 may bias the coupling end closed, as shown in FIG. 4, for example. The coupling ends 47 may include flared extensions 416, 426 that initially contact the shelving structure as the low profile coupling mechanism 40 is inserted under the shelving, such that skirting need not be removed. The shelving structure contacts the flared extensions 416, 426 forcing the coupling ends 47 apart, such that the structure is inserted into a gap 471 defined between the coupling ends 47 before the flared extensions 416, 426 close on structural portion of the shelving that is fitted into the gap 471, such as a leg or a foot of the shelving that contacts the floor. Lever arms 41, 42 may be moved toward one another to facilitate insertion of the structure into the gap 471, if necessary or desirable. The lever arms 41, 42 evidence the insertion and proper positioning of the coupling mechanism 40. The bump stop 36 is adjustably connected with a coupling member 361 attached to a base plate 48 by a structural member 362. In the example of FIG. 4, the lever arms 41, 42 are limited in the distance between them by a u-shaped limiter 49, and the limiter serves to connect the truck coupling mechanism 34 to the base plate 48, also. The truck coupling mechanism 34 may be coupled to the jack of a truck 10 using the coupling pin 50 and the retaining pin 51, such that the coupling mechanism 40 raises and lowers when the jack raises and lowers, allowing shelving to be mobilized by the truck 10.

For example, when a leg of a gondola that extends to the floor, supporting the gondola, is to be coupled to the coupling mechanism, the coupling mechanism is maneuvered such that the gondola leg or foot fits between the flared extensions 416, 426 of the coupling end 47. The gondola leg or foot contacts the flared extensions, displacing the flared extensions outwardly by pivoting at two attachment points 411, 421 until the gondola leg clears the flared extensions 416, 426. As the gondola leg or foot clears the flared extensions 416, 426, the coupling end 47 closes on the gondola leg or foot, coupling the coupling mechanism onto the gondola leg or foot; the biasing mechanism 43 applying a force on the coupling end. In one example, the bias force of the biasing mechanism 43 is sufficient to fixedly clamp the coupling end 47 to the gondola leg, allowing the gondola leg to be lifted by raising the coupling mechanism using a jack. The leg or foot may be released by pressing the lever arms 41, 42 toward each other, for example, when the leg or foot is returned to contact with the floor by lowering the jack of the truck 10.

In an alternative example, the bias force is not adequate to fixedly clamp the coupling end to the gondola leg or foot. Instead, the adjustable bump stop 36 adjustably engages an outwardly facing surface of a portion of the gondola, while the coupling end 47 engages a surface of a portion of the gondola opposite of the outwardly facing surface in contact with the bump stop 36. The bump stop 36 is capable of clamping the gondola leg or foot between the clamping end 47 surface engaging the leg or foot and the bump stop 36, such that the jack is capable of raising the coupling mechanism, which raises the gondola leg or foot, when the coupling mechanism 40 is clamped to the leg or foot of the shelving.

The coupling mechanisms 30, 40 may be attached to a jack of a mobilization truck 10 in the same manner, interchangeably, depending on the configuration of the shelving, for example. In this way, the user is allowed to choose any of the examples of coupling mechanisms as needed to engage different types of gondola structures using the same mobilization truck 10.

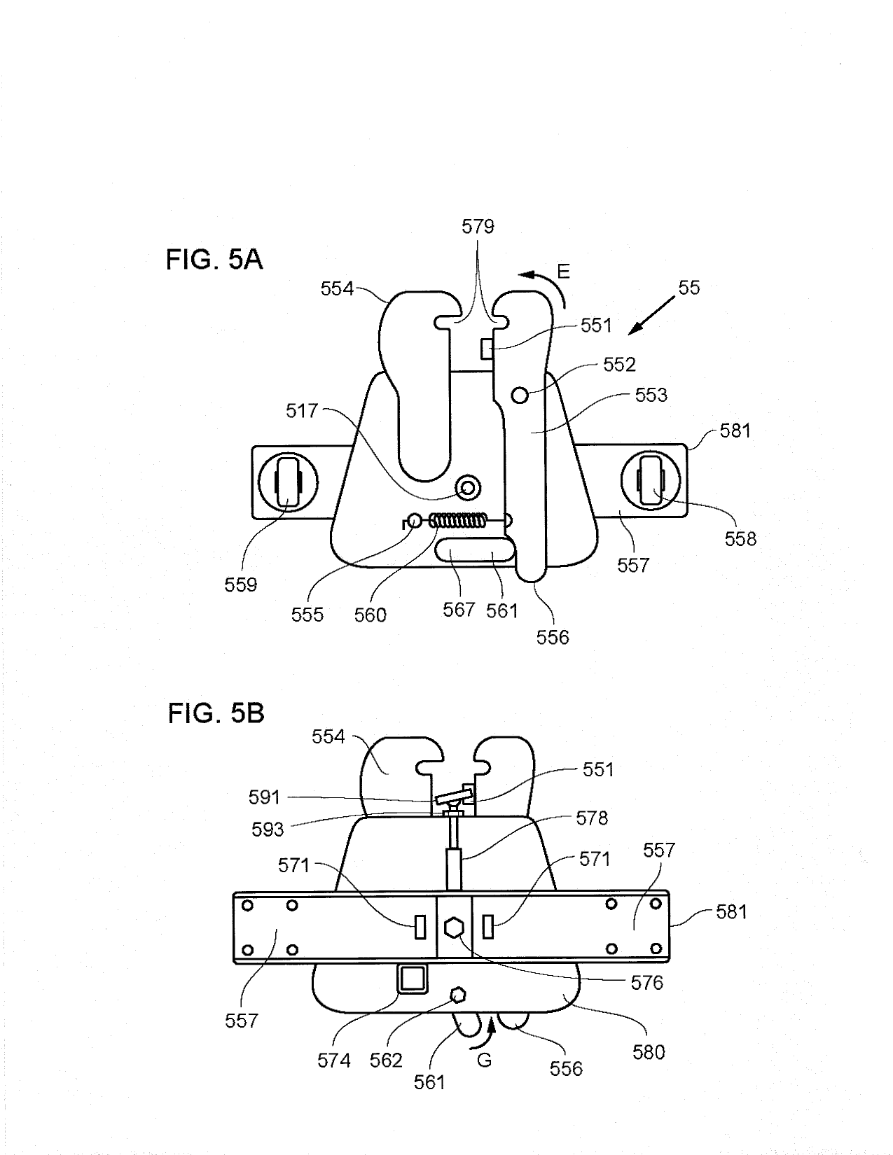

FIGS. 5A and 5B illustrate another example of a scissor mechanism 55 used in a mobilization system. Jaws 579 extend from a mobilization plate 580 and are capable of being closed onto a portion of a gondola or other shelving support for raising and mobilizing the shelving. The jaws 579 are defined by a fixed extension 554, which may be welded on the bottom of the plate 580, and a pivotable member 553, which is attached at a pivot point 552. An adjustment mechanism 551 is threaded into the jaw face of the pivotable member 553, which provides for an adjustment of the gap between the two jaws 579. The pivotable member 553 may be pivoted in a direction E for closing the jaws 579 on a portion of the shelving. The plate 580 is attached to the bottom of a C-shaped beam 581, the beam 581 having a flat central portion with two flanges extended upward from the flat central portion. For example, a bolt may be engaged with a threaded attachment member 517, which may be used for raising and lowering the plate 580 in relation to the beam 581, also.

In the Example of FIG. 5B, two slots 571 are machined in the flat portion of the beam 581 disposed symmetrically about a central lift bolt 576 for attaching spacing bars between this beam 581 and a neighboring beam, such that the distance between beams is maintained during mobilization. For example, four bolts are shown for attaching the wheels 559, 558, shown in FIG. 5A, to the attachment regions 557 of the beam 581, for example.

In one example, the lift bolt 576 of FIG. 5B adjustably connects the attachment mechanism 517 of plate 580 to the beam 581, such that the plate 580 may be adjusted up and down in relation to the beam 581 by using a wrench (not shown) to turn the bolt 576, which threadingly engages the attachment mechanism 517, for example. In one example, a bottom surface of the jaws 579, which are disposed on the underside of the plate 580 are capable of extending all of the way down to the ground without disengaging the attachment mechanism 517 from the lift bolt 576, which prevents accidental disengagement when the shelving is raised above the ground. The base plate 580 may be coupled to the attachment mechanism 517, releasably, by a pin 50 and insert 34, such as illustrated in the example in FIG. 4, for example.

A spring 560 or other biasing mechanism may be used to bias the jaws 579 open, while a pivoting bar 561 may be pivoted into position, as illustrated in FIG. 5A, to close the jaws 579. As shown in FIG. 5B, the pivoting bar 561 may be pivoted in either direction G, working in conjunction with the biasing mechanism to open and close the jaws 579. For example, the head 562 may be connected by a shaft to the bar 561 for pivoting the bar using a wrench. In one example, a single wrench, having a single size, may be used for opening and closing the jaws 579 and raising and lowering the plate 576. A fixture 574 may be used for mounting a mobilization handle. An adjustable bumper 591 may be pivotably and adjustably mounted to the plate 576 and may be extended using a wrench until the bumper 591 contacts the portion of the shelving, as previously described in relation to the bump stop 36 illustrated in FIG. 4. A nut-like mechanism 593 may be turned with a wrench to extend or retract the bumper 591.

The features of the examples may be combined and modified and are not intended to be limiting to the claims. Instead, the claims may be drawn to combinations and variations on the examples.

What is claimed is:

1. An apparatus for raising and mobilizing stocked shelving, comprising:
a pair of opposed jaws, each of the jaws being defined at the end of one of a pair of rigid members extending from a base plate, at least one of the rigid members comprising a pivot point and being pivotably coupled to the base plate such that the jaws are capable of being opened and closed by pivoting the at least one of the rigid members about the pivot point;
a biasing mechanism coupled with the at least one of the rigid members, such that the jaws are biased either open or shut; and
an attachment mechanism for coupling the base plate to a structural member of a mobilization device, wherein the mobilization device comprises a raising and lowering mechanism for raising and lowering the base plate in relation to the mobilization device, and the mobilization device rolls over the ground for mobilizing stocked shelving.

2. The apparatus of claim 1, wherein the mobilization device includes a pair of castor wheels disposed on opposite ends of the structural member.

3. The apparatus of claim 2, wherein the attachment mechanism threadingly engages a portion of the structural member.

4. The apparatus of claim 3, wherein the portion of the structural member comprises a bolt.

5. The apparatus of claim 4, wherein the base jaws are capable of extending all of the way down to the ground without disengaging from the bolt.

6. The apparatus of claim 1, wherein the biasing mechanism is mounted under tension to an end of the at least one of the rigid members opposite of the pivot point from the jaw of the at least one of the rigid members, such that the at least one of the rigid members is biased open by the biasing mechanism.

7. The apparatus of claim 6, wherein the biasing mechanism is a spring.

8. The apparatus of claim 7, wherein an end of the spring opposite of the at least one of the rigid members is attached to the plate and is not attached directly to the other of the rigid members.

9. The apparatus of claim 1, wherein the other of the rigid members is fixedly mounted to a surface of the base plate and cannot pivot in relation to the base plate.

10. The apparatus of claim 1, wherein the other of the rigid members is pivotably mounted to a surface of the base plate and is coupled to the at least one of the rigid members by the biasing mechanism,

11. The apparatus of claim 10, wherein the biasing mechanism is compressed between the pair of rigid members.

12. The apparatus of claim 11, wherein the biasing mechanism is compressed between the pair of rigid members on an end opposite of the pivot point from the jaws, such that the pair of opposed jaws are biased closed, and the ends of the pair of opposed jaws extend outward from the pivot point are tapered such that inserting a portion of the shelving between the ends of the pair of opposed jaws opens the jaws around the portion of the shelving, such that the pair of opposed jaws closes onto the portion of the shelving when the portion of the shelving is fully inserted between the pair of opposed jaws.

13. The apparatus of claim 1, further comprising an adjustable bump stop extending from the base plate such the adjustable bump stop contacts a portion of the shelving when the shelving is inserted between the pair of opposed jaws.

14. The apparatus of claim 1, further comprising a jack, the jack being capable of being raised and lowered and being coupled to the attachment mechanism, such that raising and lowering of the jack raises and lowers the base plate.

15. The apparatus of claim 1, wherein the biasing mechanism is mounted under tension to an end of the at least one of the rigid members opposite of the pivot point from the jaw of the at least one of the rigid members, such that the at least one of the rigid members is biased open by the biasing mechanism, and a pivoting member is pivotably coupled to the base plate such that in a closed position, the pivoting member engages an end of the at least one of the rigid members such that the pair of opposed jaws are closed and are prevented from opening until the pivoting member is pivoted to an open position.

16. The apparatus of claim 15, wherein the pivoting member is coupled to a nut on an opposite side of the base plate by a shaft extending through a hole in the base plate, such that a wrench is capable of pivoting the pivoting member between the open position and the closed position.

17. A method of using the apparatus of claim 1, comprising:
opening the pair of opposed jaws;
inserting a portion of stocked shelving between the pair of opposed jaws;
closing the pair of opposed jaws onto the portion of the stocked shelving such that the pair of opposed jaws grip the portion of the stocked shelving without slipping;
raising the base plate and the portion of the stocked shelving above the ground; and
mobilizing the stocked shelving.
